(19) United States
(12) Patent Application Publication
(10) Pub. No.: US 2016/0267615 A1
(43) Pub. Date: Sep. 15, 2016

(54) Calculating an individual's national, state and district education and education environment index and recommending statistically proven methods of improvement tailored to input from a user such as a child's parent

(71) Applicant: Amit Mital, Bellevue, WA (US)

(72) Inventor: Amit Mital, Bellevue, WA (US)

(73) Assignee: Amit Mital, Bellevue, WA (US)

(21) Appl. No.: 14/544,973

(22) Filed: Mar. 12, 2015

(51) Int. Cl. G06Q 50/20; G09B 7/00

(52) U.S. Cl. CPC G06Q 50/205; G09B 7/00

(57) ABSTRACT

A system for evaluating a student's education value and proposing method of improving said value. The system receives public and private information about a student's education. The system obtains comparative education value by comparing attributes and rankings among students of different populations. The system offers estimates of education value change for a student by modifying various attributes of a student.

### CROSS-REFERENCE TO RELATED APPLICATIONS

This application claims priority from U.S. Provisional Patent Application No. 6,1950,726 filed on Mar. 10, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The described technology is directed to the field of data organization and manipulation, specifically data related to public education.

### BACKGROUND OF THE INVENTION

Annual primary public education funding is expected to surpass one trillion US Dollars in 2016, largely supported by state and local government taxation. In accord with this arrangement, it falls upon local school districts to dictate the structure, curriculum, and strength of the education provided to a majority of the country's youth. Although this is an efficient model, the individuals most invested in the growth of any singular student are that student's parents, who possess limited influence over education. Control—or even evaluation—of a child's education by a parent is difficult, if not impossible, with the current schema. One method of control available to parents is to relocate their permanent residence to an alternate school district. This possibility is not feasible for some, and for the rest, their choice is guided by the adjectives “good” and “bad” in regards to the quality of schools.

State and local governments, as part of their duties of managing public education, maintain extensive records of students' progress. Information such as test scores, report cards, and attendance can be used to evaluate a school's ability to educate, but this data is useless to the public unless it can be skillfully organized and filtered for comparison to other schools across the country.

While it may be possible to design systems that aggregate public education data across states and calculate a score for each school, this number is useless to individuals unless that score can be correlated to success later in life, as this is the ultimate goal for any parent: to guarantee their child's future prosperity.

Furthermore, a school's rank is not the sole determinant of a student's success. A multitude of factors, including many that are not captured by public data, affect the quality of education a student receives. As a small set of examples, playing an instrument or a sport, participating in debate or a science team, or even having access to a public library may positively impact a child's education. There are an infinite number of variables that contribute to education, with no method of quantifying the benefit.

In light of the deficiency of transparency and control available to parents, a new approach to evaluating and improving an individual child's education, tailored to each student's individual record, as well as having a high level of accuracy, and being inexpensive and convenient, would have significant utility.

### BRIEF DESCRIPTION OF THE DRAWINGS

FIG. 1 is a flow chart illustrating the progression of a typical first-time user of the system.

FIG. 2 is a block diagram depicting the interaction between various systems and data manipulated by the system during the calculation of Educational and Educational Environment Indices.

FIG. 3 displays an example of the type of data contained in a student's profile entered by a user.

FIG. 4 is a spreadsheet containing the results of calculating a student's cumulative GPA through the combination of data imported from the public school repository and personal grade information entered by a user.

FIG. 5 illustrates a flow chart of an embodiment of the system generating real estate or rental options to a user.

FIG. 6 is a map diagram depicting sample results of a search identifying similar homes in nearby alternate school districts to that of the user's current home.

### DETAILED DESCRIPTION OF THE INVENTION

A system for automatically determining a persistent index for a student's quality and value of education and education environment that can be further tailored to input from a parent user or that student is described.

In some embodiments, the system uses a web site to receive basic educational information about a student from a user and subsequently displays an initial index of the education based upon the information provided by the user in comparison to an aggregation of public and private education data previously collected by the system. Some user inputs during this initial step may include a residential address (or for more privacy-conscious individuals, a zip code), the student's grade level, a selection of a school in the district containing the residence, and at least one grade for an identified course, but in the ideal scenario, the results from at least one complete personal report card. The system then calculates an index of the student's educational progress for each year grades were provided and displays the results to the user for comparison to students in the same classroom, grade level at the school, district, city, state, and country.

In some embodiments, the system permits the user to provide additional, corrected, or updated information in order to complete a student profile from which a revised education index can be calculated. Such attributes include, but are not limited to, additional past report cards, attendance history, or participation in extracurricular activities. In some embodiments, the system displays the results of refining its evaluation in a manner that makes clear how the valuation was affected by the different information provided by the user.

In some embodiments, the system calculates an education environment index based on public and private information that describes the quality of education the student is currently enrolled in. The system uses a multitude of variables to calculate this index, including, but not limited to, standardized testing scores, instructor evaluations, and local tax-records. The system provides the functionality to filter or aggregate the education environment index for comparison to schools, districts, cities, or states across the country, generally or by individual components. In some embodiments, the system permits the user to provide additional, corrected, or updated information in order to increase or decrease the education environment index of the school their student attends. Such information is limited to personal information, such as a positive interaction with a teacher during a student-teacher conference, or a negative comment regarding a campus' sanitation. In some embodiments, the system displays the results of refining its valuation in a manner that makes clear how the valuation was affected by the different information provided by the user. Additionally, the public and private data can be further enhanced by “user generated content”—feedback provided by users (e.g., parents or students) about teachers, schools and courses.

In some embodiments, the system provides recommendations for improving a student's education index. The system predicts the potential positive or negative impact of a variety of impacts on a student's index, including, but not limited to, switching to courses taught by different instructors, moving to a new permanent residence in a different school district, or supplemental instruction such as tutoring or peer study groups. Calculations of the impact are the result of automatic analysis of the quantitative and qualitative successes of similarly situated students using the system described herein.

The present invention may operate on any combination of devices capable of operating the system. At the time of this patent's filing, the preferred embodiment includes a computer system including at least some of the following components: one or more central processing units (“CPUs”) for executing computer programs; a computer memory for storing programs and data—including data structures, database tables, or other data tables, etc.—while they are being used; a persistent storage device, such as a hard drive, for persistently storing programs and data; a computer-readable media drive, such as a CD-ROM drive, for reading programs and data stored on a computer-readable medium; and a network connection for connecting the computer system to other computer systems, such as via the Internet, to exchange programs and/or data—including data structures. While computer systems configured as described above are typically used to support the operation of the system, one of ordinary skill in the art will appreciate that the system may be implemented using devices of various types and configurations, and having various components. Additionally, those skilled in the art will appreciate that the computer system described above can be changed without affecting the use of the invention described herein.

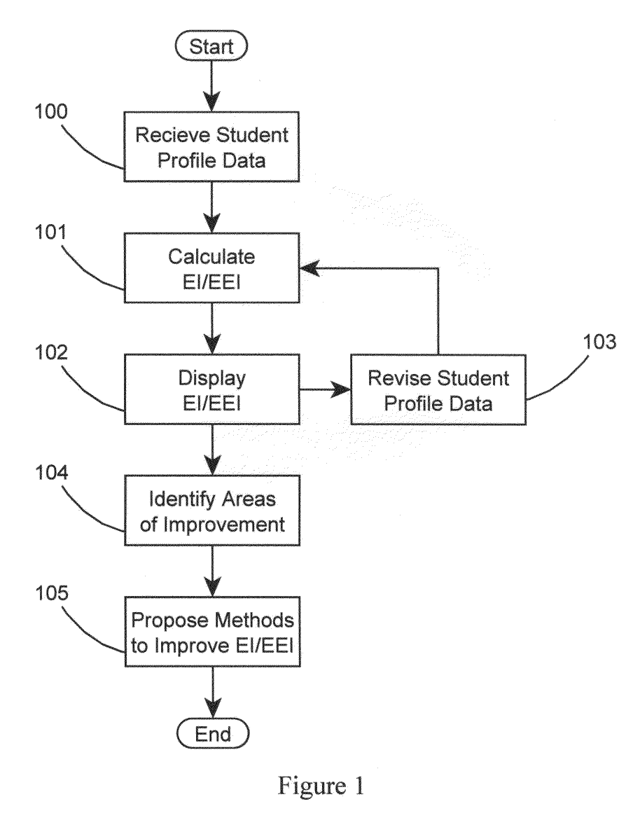

FIG. 1 is a flow chart illustrating a progression of a typical first-time user of the system. A user may access the system through any number of devices capable of receiving and transmitting Internet data through a graphical interface, such as a computer, mobile phone, tablet, or other device possessing an Internet connection and website browser. Upon first accessing the system, a user is presented with various interfaces 100 for entering data which will become the basis of a student profile. In addition to some general demographic information, the system prompts the user for scholastic data, which will then be used to calculate the Education Index (EI) and Educational Environment Index (EEI) 101. During the input phase 100, a minimum amount of information is required to generate a student profile. This information includes the selection of the student's school of current enrollment, a residential address or zip code, and the input of grades and courses the student has received evaluations for. Because the current state of public schooling data does not include personally identifiable information, this manual entry of grades and courses is required in the current embodiment. If future versions of this data include personally identifiable information, the requirements of this step may be relaxed and convenience and ease of use increased. Upon satisfactory completion of a student profile, the system calculates current Educational and Educational Environment Indices 101.

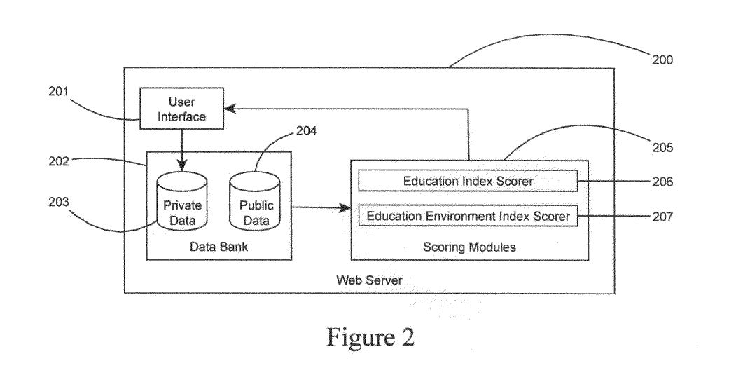

FIG. 2 is a block diagram depicting the interaction between various systems and data manipulated by the system during the calculation of Educational and Educational Environment Indices 101. These systems may be programmed in any suitable programming language and typically hosted on one or more webservers 200. A User Interface 201 (described in FIG. 1, above) provides intuitive interaction between Data Bank 202 and Scoring Modules 205. In some embodiments, Data Bank 202 segregates Private Data 203 from Public Data 204. Private Data 203 contains data entered by users, including demographic information, student and teacher evaluations, and additional information relevant to the operation of the system. Public Data 204 includes data that has been collected by schools or government organizations and made available to the system for analysis, comparison, or other feature of the system. Such data includes, but is not limited to public school information, public tax information and records, and real estate or rental information. Scoring Modules 205 contains the methods required to calculate relevant indices, by invoking either the Education Index Scorer 206 or Education Environment Index Scorer 207. The Scoring Modules 205 receive data from the Data Bank 202.

Education Index Scorer 206 operates by importing the student transcript information from Private Data 203, and calculating the cumulative grade point average (GPA) for the student. A typical calculation of cumulative GPA is completed by dividing the sum of each course's credit hours multiplied by the value of the grade received in each course by the total number of credit hours attempted, as follows:

$$Cum . GPA = \frac{{\sum }_{i = 0}^{n} {G}_{i} {V}_{i}}{{\sum }_{i = 0}^{n} {V}_{i}}$$

Where n=number of courses being used in this computation, i=a particular course the student has completed, Gᵢ is equal to the value of the grade received in course i, and Vᵢ=the number of course credits associated with that course.

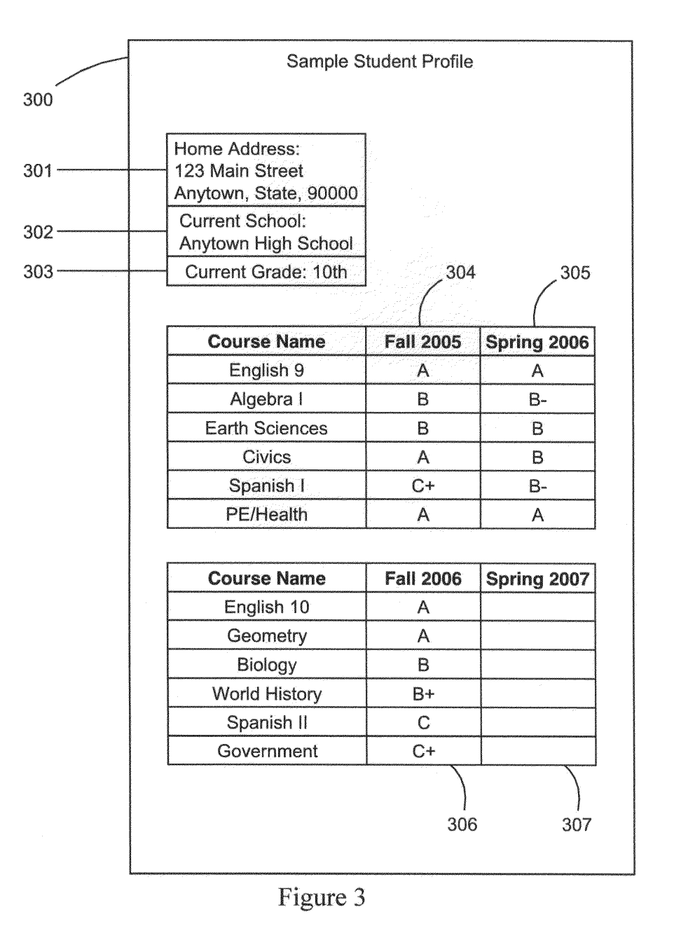

FIG. 3 displays an example of the type of data contained in a student's profile entered by a user. There is significant variety across schools regarding student assessment, however FIG. 3 represents the typical modern transcript maintained by public schools. Although assessment methods may mutate in future embodiments, a student's cumulative GPA, or another generic measure of achievement, will always be easily calculable. Such assessment measure may be substituted for cumulative GPA for users entering data for students attending schools who use such alternate assessment measures. The Sample Student Profile 300 includes the student's Home Address 301, School of Attendance 302, Current Grade Level 303, and student's evaluation of three completed high school semesters 304-306. Note that each high school year in this case includes two semesters. Some users may see a variation of this embodiment if the student attends a school with a different record-keeping methodology, for example year-long courses instead of division into two semesters. In this case, we can see that the user has entered course and assessment information for three semesters 304-306, and one semester 307 has not been entered or is unavailable.

Returning to FIG. 2, information regarding the student's current school assessment system is imported from the Public Data 204. This data includes the necessary values to complete the calculation of the student's cumulative GPA, or alternate assessment measure. In the cumulative GPA calculation phase, this data is the credit value of each course entered for the student.

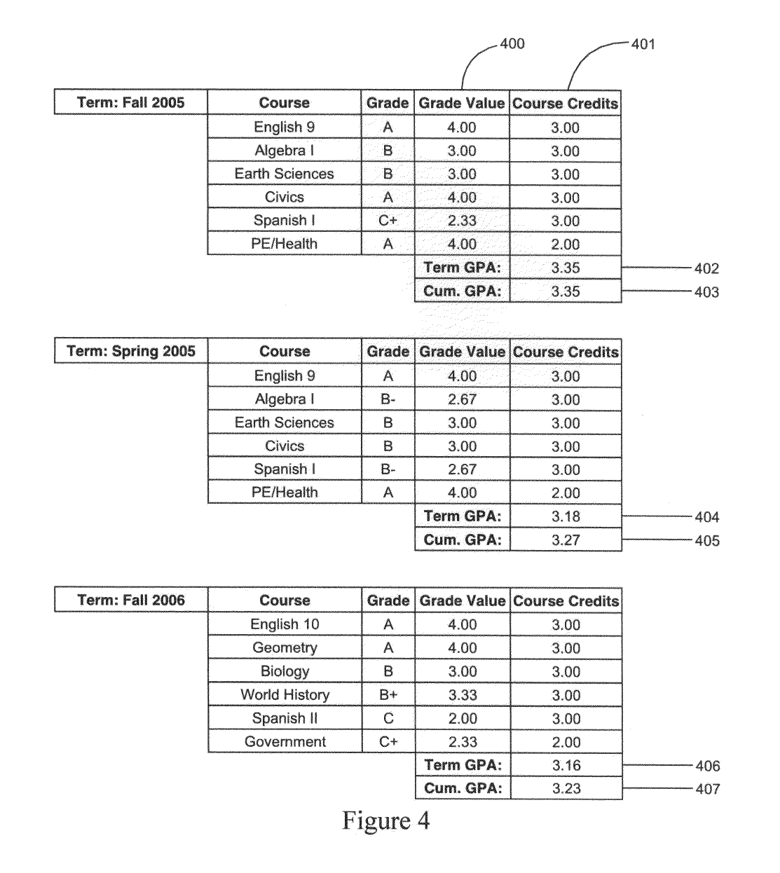

FIG. 4 is an example spreadsheet containing the results of calculating a student's cumulative GPA through the combination of data imported from the public school repository and personal grade information entered by a user. Grade Value 400 and Course Credits 401 are provided in the public school data repository. Grade Value 400 is the numerical value associated with the assessment of a student. In a typical high-school assessment methodology, Grade Value 400 is calculated according to Table 1, shown below.

TABLE 1

| Letter Grade | Grade Value |
|---|---|
| A+ | 4.33 |
| A | 4.00 |
| A− | 3.67 |
| B+ | 3.33 |
| B | 3.00 |
| B− | 2.67 |
| C+ | 2.33 |
| C | 2.00 |
| C− | 1.67 |
| D | 1.00 |
| F | 0.00 |

Course Credits 401 pertains to the value of each course completed by the student. In the example, each semester counts for half a credit, a full year comprising one credit for each completed course. Although Term GPAs 402, 404, and 406 and intermediary Cumulative GPA 403 and 405 are easily calculated and available for display to the user, only final Cumulative GPA 407 is crucial to the calculation of a student's Educational Index in this embodiment. Alternate embodiments may treat intermediary calculations differently, reflecting users' evolving preferences regarding the calculation of Education and Education Environment Indices.

Once the system has completed calculating Final Cumulative GPA 407, the system may proceed to the next step of calculating class rank and percentile. This calculation is completed after importing additional information from the public school data repository. Relevant data to the calculation of class rank and percentile are the cumulative GPAs of the peers of the involved student and the total number of students in the class with the involved student. To calculate class rank, the system orders the selected students of the class by GPA in descending order, arranging the student with the highest GPA is in position 1, and the student with the lowest GPA in the position equal to the total number of students in the class. In the event of ties, where students share the same cumulative GPA, the rank is shared between them and subsequent students receive ranks equal to their original ranking minus the number of students sharing ranks above them.

To calculate percentile rank, the number of students below an individual student's rank is divided by the total number of students in the class. For example, a student with rank 91 out of a total of 1,521 students has performed better than 1,430 students and receives a percentile rank of 0.94017, or 94.017%.

The final calculation necessary to compute a student's Education Index is to transform the percentile rank into an index, by multiplying either the decimal rank by 1000, or the percentage ranking by 100, and then excluding any decimal value in order to achieve an integer value between 1000 and 0. For example, in the case of the student with a percentile rank of 0.94017, their Educational Index would be equal to 940.

In calculating the Educational Environment Index of a student, the system, in some embodiments, combines the standardized testing scores and teacher evaluations of a student's school and compares those values to other school as available in the public school data repository. The data used to calculate a student's Educational Environment Index may change depending on the data available to the system, including additional public schooling information as well as user-provided information. In the embodiment discussed herein, standardized testing scores and public teacher evaluation scores are used to calculate a student's EEI. Specifically, the EEI in the current embodiment is equal to the average of all the enrolled students' standardized testing scores S̅T̅S̅ multiplied by a weight modifier wₛₜₛ added to the average of all the current teacher evaluation scores T̅E̅ multiplied by a weight modifier wₜₑ, as shown in the formula below.

EEI=wₛₜₛS̅T̅S̅+wₜₑT̅E̅

Weights wₛₜₛ and wₜₑ may be supplied by expert statistical evaluation and may fluctuate over time, as additional user information is input into the system. Each weight is a decimal value between 0 and 1 and the sum of all weights is equal to 1. In future embodiments when additional EEI characteristics and weights are computed, the EEI formula will be modified to the following:

$$EEI = {\sum }_{i = 0}^{n} {w}_{i} {\overline{c}}_{i}$$

Where n is the total number of characteristics included in the EEI calculation, i identifies a particular EEI characteristic, wᵢ is equal to the weight of that particular characteristic, and c̅ᵢ is equal to the average of the scores of that characteristic.

Once the values for calculating an EEI have been gathered, the system may offer several ranking modes for browsing by the user. Specifically, the system may rank a student's EEI (which is identical for all students at the same school in this embodiment) across schools at the district, state, and national level, providing a user with an overall comparison point for the student's education environment.

Returning to FIG. 1, once a student's EI and EEI have been calculated, these values may be displayed to the user 102. At this point, a user is presented with the option to return to a previous interface and add, update, remove or otherwise revise the information contained in a student profile 103. Once the initial student profile has been created, a user can revise a student profile 103 from any position within the system, however this relationship is omitted from FIG. 1 for clarity.

After establishing initial or updated EI and EEI values, the system may present the user with characteristics of the student's education, which may be good targets for improvement, in comparison to other students' EI and EEI values and public and personal data. The process for locating these targets relies on a more granular comparison of scores and attributes, for example, if a student's teachers receive evaluation scores lower than peer-instructors at the same school location, the system may recommend moving the student to courses taught by those peer-instructors. In another embodiment, the system may recommend tutoring programs or peer-study sessions when those activities have proven to improve students' Education Indices as recorded by personal data input into the system.

In another embodiment, the system uses publicly available tax data to highlight a potentially under-funded institution. Having previously collected current and historical tax data for all public school districts, the system may compare schools contributing high EEIs to those generating lower scores and determine if these differences may be caused by variations in taxation and spending. Relationships such as these may be computed in a variety of means, including but not limited to statistical analysis such as logistic regression, machine learning, and neural networks. After a relationship has been computed, it is provided to the user 104.

In some embodiments, it may be desired to predict changes in a student's EI or EEI. Such changes may be sought out by users interested in improving their child's EI and EEI through changing schools or districts. The system may use these predictions to generate recommendations unique to each student.

The system creates predictions by calculating hypothetical EI and EEIs for a student by replacing one or more variables with placeholder values to test the effect of a change on a corresponding index. For example, the system predicts the EEI of a student at a different school by recalculating that student's EEI with values attributed to the different school in place of that student's actual school. By comparing original and hypothetical EEI scores, the system is able to generate recommendations to improve a student's education.

One embodiment of the system is concerned with presenting a user with real estate currently available for sale that would increase a child's EI or EEI. In this embodiment, the system combines publicly available real estate data with predictions of a student's EI and EEI at various schools and districts.

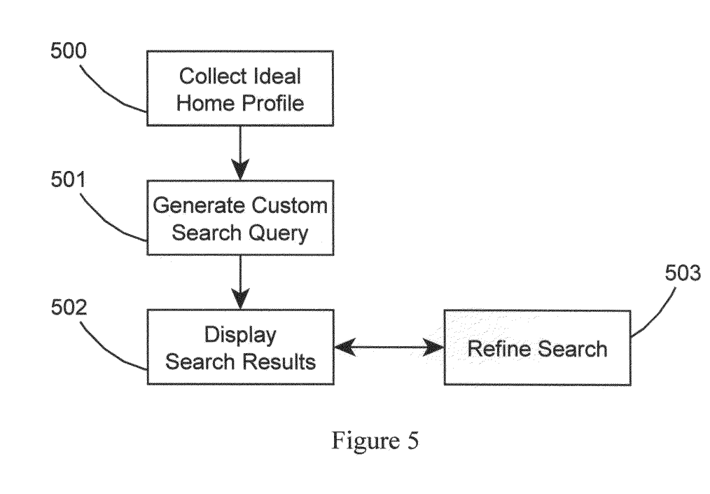

FIG. 5 illustrates a flow chart of an embodiment of the system generating real estate or rental options to a user. In order to form recommendations of similar housing options, the system requires an Ideal Home Profile (IHP) as a starting point from which to generate results. The system collects information to generate an IHP 500 in one of several ways, including, but not limited to, importing the characteristics of a user's previously entered address, providing the user with an interface for describing the characteristics of the home they would like to search for, or a combination thereof. This IHP includes many features, but in most cases will be based upon size (including number of bedrooms and bathrooms), rental vs. purchase, type of building, and rental or purchase price. The combination of features describing an IHP may be modified at any time by a user and are virtually unlimited.

Once an IHP has been created, the system generates a custom search query 501 based on this IHP, incorporating a range of values typical of a user's search of real estate. For example, if a user establishes an IHP of two bedrooms, two bathrooms, and an ideal price of $200,000, the system may formulate a query for two bedroom homes with between two and three bathrooms listed for a maximum of $250,000. Automatically set ranges are determined by manual or programmatic analysis of usage statistics corresponding to the method users search for housing listing, and may evolve over time. Similarly, the custom search query incorporates any number of features available in the IHP, as determined by analysis of usage patterns.

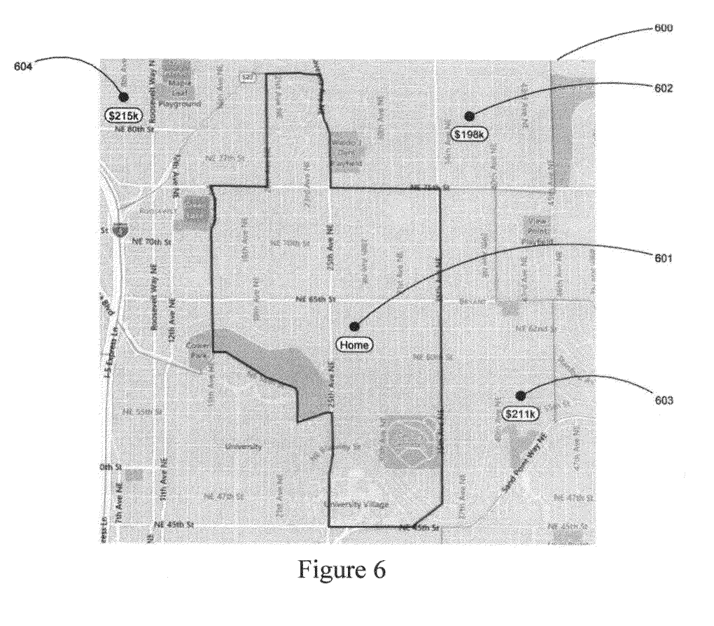

After the custom search query is created, the system accesses the public home database and queries the database for homes similar to the IHP, finally displaying the results to the user 502. FIG. 6 is a display diagram depicting sample results of a search identifying similar homes in nearby alternate school districts to that of the user's current home. Map 600 contains a geographical overlay centered on the user's current residential address 601 with nearby available homes identified by a marker 602-604. In some embodiments, the houses are identified by a label including, but not limited to, the price of the home or the increase in EEI that living at the home will provide to the student. Selecting any of the homes presents the user with additional details regarding that home, including, but not limited to, number of rooms, square footage, amenities, and interior photos. In FIG. 6, Home 601 is outlined by a solid line representing the school district Home 601 belongs to.

Returning to FIG. 5, simultaneous with the display of results, the user is presented with varying options to broaden or narrow their original custom search query 503. Although the options for crafting such a query are virtually unlimited, in most cases searches may be instantly modified with a specification of maximum distance from a central point (in some cases, the user's current home address), or the selection of a specific neighborhood, desired square footage, number of rooms, and other selections typically included in real-estate search sites. In some embodiments, modifying the search simultaneously updates the results in the corresponded map window.

In some embodiments, the system may offer supplementary services that would provide utility to a user of a system. Some examples of supplementary services include, but are not limited to, recommending nearby or online tutoring programs or extra-curricular activities that are likely to improve a child's EI or EEI, connecting a user with a real estate agent or broken for a home identified on the system, and recommending books or online courses other have found to increase a student's EI or EEI.

We claim:

1. A method in a computer system for generating a display relating to a student's education valuation, the method comprising:
collecting public information about a population's educational system;
retrieving the private educational history of an individual student living within said population;
calculating the relative cumulative ranking of said student among the student's classmates;
calculating the student's education value by applying a weighted mean formula to the public data collected about a student's population; and
causing to be displayed a characterization of the student's personal education value that is based on comparison to a multitude of populations.

2. The method of claim 1 wherein the collecting and calculating acts are performed for each student among a population of students.

3. A method in a computer system for generating a display relating to potential improvements in a student's education valuation, the method comprising:
estimating updated education valuations based on automatically comparing the attributes of a current student to attributes of students with higher and lower education valuations; and
causing to be displayed attributes exhibited by similar students which are estimated to result in an increase in education valuation for said student.

4. The method of claim 3 wherein the attributes estimated to result in increased valuations are housing options in different school districts.

5. The method of claim 3 wherein the attributes estimated to result in increased valuations are extracurricular activities.

6. The method of claim 3 wherein the attributes estimated to result in increased valuations are tutoring or supplemental education programs.

7. The method of claim 3 wherein the comparison of attributes is calculated with a neural network.

8. The method of claim 3 wherein the comparison of attributes is calculated with logistic regression.
